(19) United States
(12) Patent Application Publication
(10) Pub. No.: US 2016/0363739 A1
(43) Pub. Date: Dec. 15, 2016

(54) PERIPHERAL ENVIRONMENT DETECTION SYSTEM AND DEVICE

(71) Applicant: Thomas Edward SHAFOVALOFF, Orlando, FL (US)

(72) Inventor: Thomas Edward SHAFOVALOFF, Orlando, FL (US)

(21) Appl. No.: 15/173,604

(22) Filed: Jun. 3, 2016

Related U.S. Application Data
(60) Provisional application No. 62/170,242, filed on Jun. 3, 2015.

(51) Int. Cl. G02B 7/182; A42B 1/06; A42B 1/24; A42B 3/04

(52) U.S. Cl. CPC G02B 7/1824; A42B 3/0426; A42B 1/062; A42B 1/242

(57) ABSTRACT

This peripheral environment detection system and device accomplishes improvement of an individuals awareness of his surroundings not in line of sight, including rearward information detection while providing a platform for improving awareness and information to the forward peripheral environment. The construction of the preferred embodiment of this one piece non-complex mirrored device is of lightweight, (weighing 12 grams or 0.5 oz in its preferred embodiment adding a generic clip, low cost material, typically plastic, easily acquired and transported without danger of breakage of multiple parts, requiring little or no assembly. The device is designed to be mounted on common, low cost head gear, like ball caps, however may also be adapted in variations for attachment to other personal head gear, including but not limited to military type helmets. This device's front surface may serve as a mount for forward visibility detection by mount of lighting, such as LED's, a reflector, or used as a surface for advertising and mounting of other information detection technology, for example, used for friend or foe detection for military use, and technology incorporating chip devices commonly used, for instance, to identify vehicles on toll highways. In its simplest form this light weight device, lends itself to production for mass use improving safety for bicyclists without the expense of numerous and complex parts, while providing a technically efficient field for information detection to the rear of 180 degrees or more.

### CROSS-REFERENCE TO RELATED APPLICATIONS

Provisional application No. 62/170,242, filed on Jun. 3, 2015

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Embodiments of the present disclosure relate to forms of rear view mirror vision enhancement safety devices for the individual user, however, beyond the device in its preferred embodiment, the description incorporates beyond rear view vision, the ability to mount environment information detection technology not strictly visual in more complex embodiments which do not interfere with the embodiment in its simplest form.

The differences of this disclosure from prior art may be best seen by comparing patents such as U.S. Pat. No. 8,882,281 B2, “Peripheral Vision Safety System and Device,” Nov. 11, 2014 and U.S. Pat. No. 3,988,058 “Rear-view mirror device for attachment to accessories of the user,” Oct. 26, 1976. Each of these examples employs the use of multiple parts incorporating rods, extension bars and ball and socket joints in art spanning a time period of over 30 years. The aforementioned prior art viewed in comparison to this disclosure juxtaposes this disclosures dissimilarities and improvements over said related prior art, this disclosure being new and novel. Today most people still do not wear helmets while riding bicycles but most have a ball cap that they will wear. Getting individuals to use safety devices depends upon many things but typically, includes cost, portability and ease of use. The functionality and accessability provided by the preferred embodiment in this disclosure might just be enough to compel an individual to use a rear view device and avoid having to employ a helmet.

Mirrored devices are used to provide visual detection information rearward of an individual for a variety of purposes where maintaining a forward view is necessary at the same time. Accomplishing a rearward view, without assistance, necessitates turning away from the direction in which an individual may be moving or facing, whether on a bicycle, walking or even standing, while the environment around is changing. The danger from rearward approaching motor vehicle traffic can be just as deadly as military combat. A threat from behind in a sports competition may be a threat to winning the competition, a threat never-the-less. This device described herein provides a new level of inexpense, simplicity of construction and use, portability and along with that heightened accessability.

Human vision more readily detects movement to the sides at eye level than in peripheral vision below center and above center eye level. Perceptual accuracy is significantly heightened when the dominant eye is put to work when spatial localization involves scanning. In most of the population the left eye demonstrates dominant characteristics. This device takes advantage of these characteristics. The device may be mounted on the left or right side of the users headgear depending upon the chosen embodiments tab location. Viewing from the front the device appears to be a bloc to viewing the forward field. For a person of average vision, with eyesight in the eye opposite the side that the device is mounted, it is not. This properly positioned mirrored eye level device mounted to the front and side of the head provides infinity focus to the rear and side and with slight head movement 180 degrees or more of rearward visibility. Any perceived peripheral forward vision block is easily overcome by the slightest head movement while at the same moment providing greater rearward view coverage.

Existing art is a mix of devices that are not efficient, too complex in construction, not light weight or simple to attach, adjust, ship and use. Other prior art, including those that may be mounted on a cyclists handlebars often fixed in position, require mounting tools, are not located in the most effective field of vision for rear movement detection, are typically made of more costly materials making acquisition and therefore their use less likely and inefficient.

Those mirrored devices attached to long wires or stiff plastic rods or on swivel balls are likely to break, bend, add to vibration of the mirror, have no dedicated forward visibility mounting or advertising surface and also are more costly to construct and ship. Specifically, the preferred embodiment weighing only 12 grams (or ½ ounce), with dimensions of 10 cm×3.5 cm (7 cm including the tab) and 1.25 mm thick has the flexibility to be shipped in a letter envelope. Many devices incorporate complex adjustment systems when the device is intended to be head mounted. The head and eyes themselves provide significant mobility for adjusting the view rapidly and effectively. Further fine adjustment of this device, after initial positioning, can be accomplished by slight repositioning of the head gear used with ease as when using the brim of a ball cap for a mount. This described device employs points on the body for efficient initial set up, positioning that can be marked on the brim of a ball cap and reused over and over again. Attachment of the tab to the brim of a ball cap may be with a clip for firm temporary mounting or removal after use, and adhesive may be used after determining the best position as described herein for a permanent mount.

### BRIEF SUMMARY OF THE INVENTION

It is the object of this invention to provide rearward visual information and threat detection in a device with fewer parts, that is lighter in weight and less complex to adjust and use. This is done by using simple design and material in a way that reduces the need for user adjustment input and the opportunity for breakage of numerous complex parts. Additionally, the devices construction allows for delivery of forward peripheral information detection, whether advertising in printed form, light from an LED or other light weight mounted peripheral information detection technologies attached to its non-mirrored surface. This device delivers in a simple way what prior art has sought to achieve in an increasingly more complex manner.

Using lightweight semi-rigid but pliable plastic mirror material, the device made in one piece with a tab for attachment to a ball cap with a clip, is easily shipped and manufactured requiring fewer steps for assembly and use. After initial positioning of the device on head gear such as the rim of a ball cap before use, for instance while riding a bicycle, fine adjustment can be accomplished by slight repositioning of the head gear while in use. Further vision coverage to the rear is accomplished by small head movement which at the same time allows better forward scanning increasing the safety benefit delivered by the device.

Other devices, like those that may be mounted on a cyclists handlebars are not in the most effective field of vision for rear movement detection and are typically made of more costly materials making acquisition and therefore use less likely. Those mirrored devices attached to ling wires or stiff plastic rods and ball joints are more likely to break, bend, or have no dedicated forward visibility mounting or advertising surface and require more steps to construct and ship and are not as simple to adjust or as easy to maintain.

### BRIEF DESCRIPTION OF THE SEVERAL VIEWS OF THE DRAWINGS

Non-limiting and non-exhaustive exemplary embodiments of the present disclosure are described with reference to the following drawings in which the images described are:

FIG. 1 A perspective view of the Peripheral Environment Detection Device in its simplest form (before adjustment of the tab for attachment to head gear) from the mirror, back side facing the individual user, where tab incorporated in device for use on the left side of the individual users head gear)

FIG. 2 A perspective view of the Peripheral environment Detection Device in its simplest form from the front with example of application of print as may be used in advertising.

FIG. 3 A perspective view of the Peripheral Environment Detection Device from the front with example of attached technology providing forward visibility detection.

FIG. 4 A perspective view of the Peripheral Environment Detection Device attached to the bill of generic headgear. (not adjusted for use)

FIG. 5 A perspective view of the Peripheral Environment Detection Device tab, type that may be used when not incorporated into the mirror unit in one piece.

FIG. 6 A perspective view of the mirrored surface showing thickness before attachment of the tab for mounting for the Peripheral Environment Detection Device.

FIG. 7 A perspective view of the device from the end outermost showing thickness and position of tab incorporated into a one piece device.

FIG. 8 A perspective view of the device from the front when device mounted for use on the left front side of the bill of ball cap head gear. (tab incorporated on right top of device for use when mounted on the left side of the individual user's head gear; alternatively, tab is incorporated on the left top of the device when the device is to be mounted on the right side of the individual user's head gear)

### DETAILED DESCRIPTION OF THE INVENTION

The following detailed description makes reference to the drawings which have previously been briefly identified that include embodiments of the invention beyond its simplest form. The construction of this invention in its simplest form is by use of planar, flat, mirrored plastic material of sufficient property to allow bending a tab into a retained position from the planar plastic piece folded toward the mirrored rear side of the device not quite perpendicular to the mirror plane without fracturing the material. When cut to form one piece the tab is bent to mount on head gear such as a ball cap using various methods including clips and adhesive. See Drawing—FIG. 1. The tab can be separate. See FIGS. 4 and 5. The tab can be made on the right side of the mirror material, FIG. 1, FIG. 4 and FIG. 8, for an embodiment mounted on the front left side of head gear like a ball cap brim and, or, the opposite, right side for an embodiment mounted on the right side of a ball cap brim. The preferred embodiment weighs 9 grams, without a generic clip, and 12 grams with a generic (plastic) clip, using 1.25 mm planar plastic material to which a reflective coating or surface has been applied enabling a mirror surface on the rear of the device.

A clip suitable to firmly attach the device to the hat brim is used for initial positioning of the device before use. The bottom right corner of the device, when mounted on the front left of a ball cap brim should reflect a part of the left most side of the left eye when looking forward and the very top of the left shoulder should be just visible in the bottom mirrored surface of the device with the left eye at the same time. [This places a part of the device in front of the face, more particularly in front of part of one eye.] This tab position can be marked on the ball cap brim when attachment is not to be permanent to assist repositioning for future use, when reattached after removal or when the device has been inadvertently moved. Initial mounting of the device usually places the left most end of the device slightly forward of a horizontal line tangent to the front mid point of the ball cap brim. When using head gear such as a ball cap fine adjustment may be obtained while in motion by slight movement of the ball cap itself, instead of manipulating the device at its attachment point. Necessity for securing head gear will depend upon use of the device determined by the individual and it is expected that under some circumstances some type of securing device to head gear mount may be employed, such as a chin strap for a ball cap, in windy conditions.

Additionally, when riding a bicycle, forward visibility is maintained while using eye movement to scan rearward using the device. Turning the head slightly improves rearward visibility while at the same time improving the visibility forward. A small movement of the head can provide a side and rearward view of greater than 180 degrees using the above embodiment.

Embodiments varying from the simplest form include attaching reflectors or lighting, such as battery powered LED's to the front of the device; placement of advertising including print advertising applied to the front of the device; and attachment of additional environmental information detection technologies using the device as a light weight stiff mounting surface. Interruption of the back mirrored surface for detection technology including simple video cameras is expected and within this description.

The type and thickness of the mirrored materials may vary depending upon the embodiment's employment for use and may do so without departing from the scope of the present disclosure. And, though the various embodiments may not described with reference to any particular material, it will be appreciated that a variety of materials may be used to implement the teachings of the embodiments as described.

It is within the embodiment of this disclosure that, virtual devices, designed to imitate the various embodiments described herein, along with the visual view and results of environmental information detection technology application, whether real information (data) or imagined information (data), will be incorporated in software programs including but not limited to those used in simulation and gaming transforming that data into a video depiction on a display.

The invention contemplates embodiments that include manufacture from materials that lend itself to light use and disposable form. Construction for use as an affinity device is one of the embodiments and by definition this includes use of the device for advertising however this does not preclude an embodiment used as an affinity device from being made of more substantial material.

Reference to “embodiment,” “an embodiment” and “one embodiment” means that a particular feature, structure or characteristic described in connection with the embodiment is included in at least one embodiment of the disclosure and do not necessarily refer to the same embodiment but may depending upon the context. “Affinity device” for purposes of this disclosure means an embodiment on which advertising is affixed.

The term “head gear” refers to a hat, ball cap, helmet and generally refers to “head covering” that may include portions like the brim or rim of a ball cap of sufficiently stiff material for mounting or a surface on head covering that may be modified to accomplish mounting an embodiment of the invention without departing from the embodiments described herein. The disclosed embodiments do not preclude combining “head covering,” for instance wearing a ball cap on which the device has been mounted under a bicycle helmet that does not employ a suitable brim or rim for mounting the device.

The terms “mirror,” “mirrored,” and “reflective” material refers to generally clear plastic sheeting that may have a reflective material applied to the back or front however does not preclude the use of tinted sheeting or the use of tint with the reflective coating. Additionally, the thickness of the materials used may vary as well as the type used including but not limited to glass and metal without departing from the description. Also, the surface facing the user may not be planar or flat and still not depart from the embodiment description. The mirrored surface must be of such a quality that visual detection rearward of the user may still be accomplished. The plane of the mirror also may be interrupted without departing from the description. The front of the device is the plane of the non-mirror surface facing forward away from the user. The rear or back of the device is the plane of the mirror surface facing toward the user wearing the mounted device. The reflective surfacing or reflective coating may be on either side of the mirror surface, the front or back, however, the mirror surface faces the user and/or rearward.

Various safety features may be incorporated into the device and attachment methods, including but not limited to rounding and smoothing of edges and corners, without departing from the description.

The attachment methods may be by clips, adhesive, and by other methods determined by the user without departing from the embodiment. descriptions herein. “Firm attachment” of the mounting tab to the head gear means that the attachment means, for instance a “clip” places enough pressure on the mounting tab so that the device described is not permanently fixed to the head gear but allows for removal upon removing the attachment device, and or permits slight adjustment with the attachment device in place, yet does not permit inadvertent movement of the device while in use. As an example, a bicyclist may not need the same firm attachment as a user driving a motor scooter such as a Vespa because of the differences in speeds that may be attained where wind may place greater pressure on the described device.

Referring to FIG. 1, This perspective is from the rear of the one piece device embodiment, facing the mirrored surface, Reference Character N, with a right mounting tab that has not been bent in preparation for mounting. The dimension of Reference Character A, the width of attachment tab (on a one piece embodiment) is 2.5 cm. The dimension of Reference Character B, the length of attachment tab (on a one piece embodiment) is 3.5 cm. The dimension of Reference Character C, the width of the device, is 3.5 cm. The dimension of Reference Character M, 10 cm, may be varied from without departing from the description herein, however too large a reduction may increase the effort required to evaluate “threats” rearward and an increase may cause bloc to vision which may be a departure from the embodiments described. A reduction in size of the mounting surface on the front, by reduction of the size of the device may also be a variation from the embodiments described. The thickness of the material used for the mirrored surface, heretofore described as 0.2 mm to 0.3 mm, may vary depending upon material used and the intended embodiment's use. A thickness of 1.25 mm may be more than adequate, with the reflective material applied on the front of the clear plastic, which may need an opaque protective coating before print advertising is applied, for an embodiment including advertising or use as an affinity device

This embodiment, FIGS. 1 and 8, depicts the invention in a form that departs from prior art that employ mirrored devices attached to long wires or stiff plastic rods attached to glasses or plastic ball joints parts, and the aforementioned prior art are more complex devices, and are more likely to break, bend, have no forward visibility mounting surface for detection technology or advertising and may be more costly to construct and ship.

Referring to FIG. 2, This perspective is from the front of the embodiment of the device showing print on the front surface of the device Reference Character G. The tab which may be on the right or left top of the device is not shown.

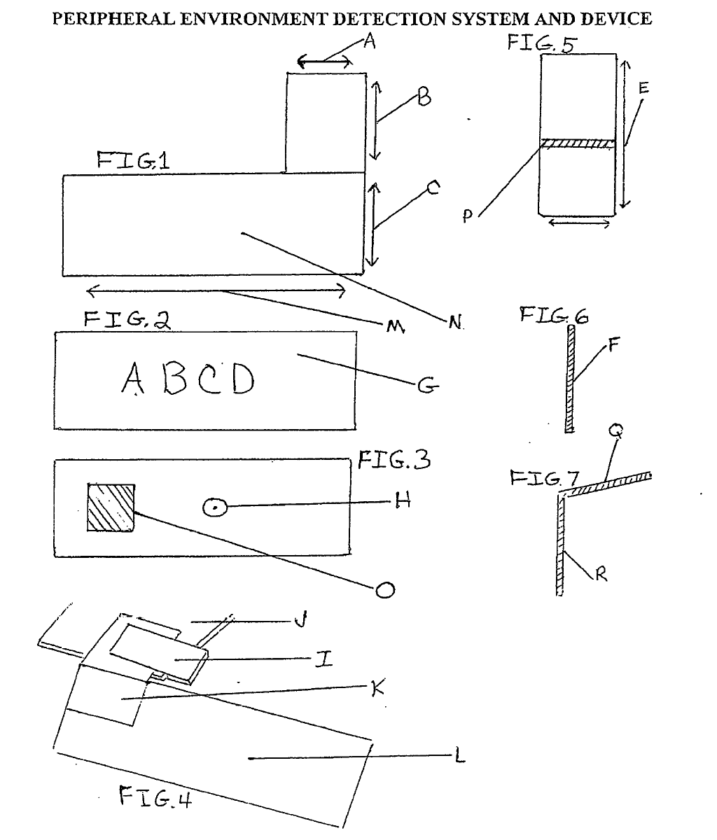

Referring to FIG. 3, This perspective is from the front of the embodiment of the device depicting an example of the attachment of chip based information detection technology, example of attached information technology generic chip, Reference Character O; and a battery powered LED, Reference Character H. This perspective is intended to depict use of the device as a system, providing for the enhancements to the preferred embodiment. A “system” for purposes of this disclosure is an embodiment departing from the preferred embodiment where additional information detection technology is attached to the preferred embodiment. However, an embodiment employing the use of an attached tab would be considered the equivalent of the preferred embodiment for purposes of defining “system” where it is attached to the mirror material for purposes of mounting to the head gear. Attachment of a solar power device would not depart from the embodiment of the device described and also place it within the systems definition.

Referring to FIG. 4, This perspective is from the left front of an embodiment of the device using an attached tab, Reference Character K, when the device is not one piece, attached to and part of the mirrored surface, Reference Character L; attached to the brim of head gear with a clip, Reference Character I an example of use of clip to attach device. Typical user would adjust the device by moving it closer to the left corner of the brim, Reference Character J, an example of headgear for attachment of device, as more fully described herein. The “tab”, Reference Character K example of attached tab (when device not one piece) would be bent further than depicted, in most instances to near a right angle to the mirrored surface facing the user. The tab may be mounted on the top of the brim or bottom. The angle formed by the mounting tab to the mirrored surface is varied by bending the mounting tab, if necessary, in making the initial positioning of the device on the head gear. Mounts incorporating a spring allowing the unit to be flipped up and out of view or back flush with the mirrored surface; making the device flat for easy carrying and mounts employing detents to adjust the vertical orientation of the device, moving the bottom closer to the user or away from the user; do not vary from the described embodiment.

Referring to FIG. 5, This perspective shows the “tab” in the embodiment where it is a separate unit before attachment to the mirrored surface. The dimensions, Reference Character D, the width of a tab when not incorporated in a one piece device, 2.5 cm; dimension, Reference Character E, 5.5 cm is the length of the tab. Reference Character P depicts the point at which the tab is bent. Preferably, the tab is bent before attachment to the mirrored surface unit to avoid separation where adhesive is used to join it to the back of the mirrored surface. Adhesive may not always be used, as where the attachment of the tab to the front of the device is made to allow for vertical movement of the mirror surface. Additionally, attachment of the tab to the head gear may also provide for horizontal movement of the device

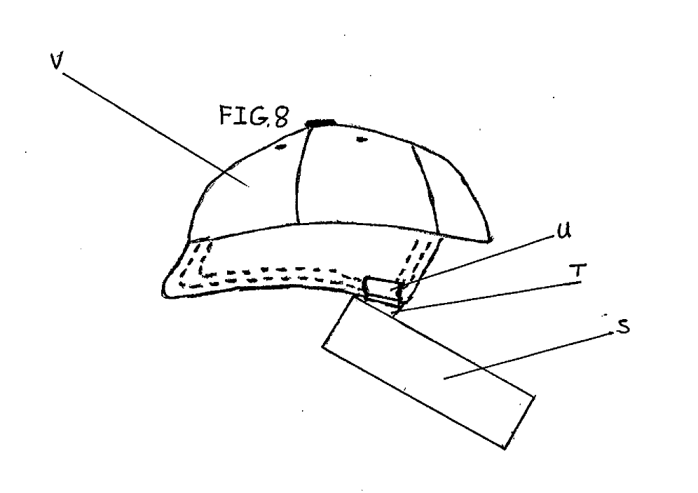

Referring to FIG. 6, This depicts a side view of the mirrored material thickness, an end view of mirrored surface when flat planar material is used. Reference Character F, in this depicted embodiment is 0.2 mm to 0.3 mm. It is suggested that this thickness provides near minimal thickness for most uses and would be a thickness of device material amenable to a disposable embodiment or one which is only expected to receive light use. It is within the description that a support may be applied to the front of the device to reduce flexibility where lighter weight material is used.

Referring to FIG. 7, This depicts a side view of the device incorporating the tab, Reference Character Q, in a one piece unit and the location of the mirror surface. The reflective material may be placed on the front, opposite Reference Character R, or on the back of the device, facing the user, the same side as Reference Character R depending upon materials used. A coating or other surface may be added to protect the reflective material from deterioration and when the surface is to be used as a mount for lighting or other devices.

Referring to FIG. 8, This is a perspective view of the device, Reference Character S, from the front left when the device is mounted for use on the left front side of the brim or bill of a ball cap type headgear, using an incorporated tab on a one piece unit, Reference Character T. This is incorporated on the right top of device for use when mounted on the left side of the individual user's head gear; alternatively, tab is incorporated on the top left of the device (while facing the mirrored surface) when the device is to be mounted on the right side of the individual user's headgear). The device embodiments include using a device mounted on both sides of the headgear. Typical “clip” mounting position is depicted by Reference Character U.

It can be appreciated that typically, when mounted on a ball cap the mirror is not situated parallel to the ground. This is an acceptable mounting of the device and requires no special clamp. It is intended that any “clamp” or “clip” or “mounting device” used, user defined, provides a firm mount, ideally just allowing enough movement for adjustments. Typical mounting of the preferred embodiment, places a small part of the top of the left shoulder (mounted on the left side of headgear) in view parallel to the bottom of the back of the device.

Referring ti FIG. 8 Reference Character S, the size of this mirror should not depart significantly from the dimensions disclosed. Reducing the size of the device increases the visual work necessary to accomplish a confidence that the field of view is complete. Increasing the size creates an unnecessary bloc to vision. “Threat” is used throughout this disclosure and anywhere the term “threat” is used, may be substituted “useful information” as the device is not intended to only provide visual detection of “threats.” Reference Character V depicts typical headgear that the device may be mounted on for use, in this case a ball cap.

What I claim as my invention is:

1. A peripheral environment detection device to be mounted on headgear comprising:
a one piece mirror surface; further comprising
a tab incorporated within the one piece mirror surface for mounting to headgear;
providing rearview vision information detection assistance;
capable of adjustment;
positionable for use in front of one eye; and
without bloc of frontal view.

2. A peripheral environment detection device to be mounted on headgear comprising:
a one piece mirror surface; further comprising
a separate tab attached to a one piece mirrored surface for mounting to headgear;
providing rearview vision information detection assistance;
capable of adjustment;
positionable for use in front of one eye; and
without bloc of frontal view.

3. The peripheral environment detection device according to claim 1 or 2, further comprising:
a frontal composition of sufficient strength and quality to support mounting of environment information detection technologies.

4. The peripheral environment detection device according to claim 1 or 2, further comprising:
a frontal composition of sufficient size and quality to attach advertising.

5. The peripheral environment detection system in claim 3, in virtual form, wherein its composition:
produces data from environment information detection technologies mounted on the virtual device; and
the data whether produced from real information or imagined, is incorporated in software programs including but not limited to those used in simulation and gaming, transforming that data into a video depiction on a display.
